(19) United States
(12) Patent Application Publication
(10) Pub. No.: US 2003/0048910 A1
(43) Pub. Date: Mar. 13, 2003

(54) Sound masking system

(76) Inventors: Kenneth P. Roy, Holtwood, PA (US); David Punia, Burlington, VT (US)

Correspondence Address: Steven L. Schmid, Womble Carlyle Sandridge & Rice, PLLC, P.O. Box 7037, Atlanta, GA, 30357-0037, US

(21) Appl. No.: 09/950,249

(22) Filed: Sep. 10, 2001

(51) Int. Cl. H04R 3/02

(52) U.S. Cl. 381/73.1; 381/71.5

(57) ABSTRACT

Disclosed is a sound masking system including an airflow unit housing at least one speaker generating a masking sound field. The airflow unit is often an air diffuser set into a conventional suspended ceiling comprised of ceiling tiles. The air diffuser provides an acoustic hole in the ceiling plane whereby sound can travel into the room unencumbered by the plane of ceiling tiles. The speaker is housed within the air diffuser and is directed into the room to be treated. The speaker is capable of producing sound waves in a frequency that masks the human voice.

### FIELD OF INVENTION

The present invention relates to sound attenuation and particularly to masking sounds within enclosed spaces.

### BACKGROUND

As the service sector of the economy grows, more and more workers find themselves in offices rather than in manufacturing facilities. The need for flexible, reconfigurable space has resulted in open plan workspaces, large rooms with reduced height and moveable partitions and suspended ceiling systems. Workstation density is also increasing, with more workers occupying a given physical space. Additionally, speakerphones, conferencing technologies, and multimedia computers with large, sound reflecting screens and voice input tend to increase the noise level of the workplace.

In closed spaces, particularly in office and meeting room settings, speech intelligibility and acoustic performance are determined by a variety of factors, including room shape, furnishings, number of occupants, and especially floor, wall and ceiling treatments. This acoustic environment determines how much sound intrusion occurs as well as the affect on listeners by extraneous noise and conversational distractions.

Typically, there are two approaches to mitigating the presence of undesired sounds in a space. It can be attenuated as it travels from the source, or it can be covered up or masked with electronically produced masking sounds. Sound masking systems typically are designed to prevent conversational speech from being a distraction in the work environment by introducing acoustically tailored sound into the environment that masks the distracting noises. Such systems are desirable even when high performance ceiling systems and furniture systems have been installed because they ensure that when the variable air volume systems are moving low quantities of air, enough background ambient sound is present to prevent conversations from being overheard and understood. Sound masking provides electronically generated background sound to achieve normal levels of privacy.

One method of masking sound effectively is to create a broad, uniform field of masking sound at the level of the listener within the space being treated. This sound field can be generated with an array of loudspeakers.

Traditionally, sound masking systems have included standard dynamic loudspeakers mounted in or above a suspended ceiling, on 12 to 16-foot centers and connected to a centrally located power amplifier. In a common configuration, the loudspeakers are oriented to fire upwards into the hard ceiling above the suspended ceiling. This provides a longer path for the sound to travel, and further disperses the sound field, depending upon the surface treatment of the hard ceiling. As the reflected sound passes through the suspended ceiling system, it is further dispersed, so that the sound field reaching the listener is relatively diffuse and consistent. With such traditional masking systems, the masking sound must be reproduced at relatively high volume levels to retain appropriate volume after passing through the acoustical ceiling tiles. Not only does this require the use of increased power for driving the speakers, it often affects the choice of ceiling tiles, and perhaps eliminates some higher performing products in favor of those that will better provide for the transmission of the masking sound.

Orienting the loudspeakers directly down through the ceiling, or mounting conventional speakers atop the ceiling panels, creates a non-uniform sound field at the frequencies of interest, with some areas sounding louder and some sounding softer. Compensating for this requires the use of many more speakers at considerably higher cost. The penalty for firing the speakers upwards, however, is that considerable additional power is required to drive the speakers to realize the desired sound levels at the listener.

Furthermore, facilities with numerous small offices have partitions and walls which often are moved without regard to the placement of speakers within the ceiling. As a result, loudspeakers located 12 to 16 feet apart in the ceiling can fall outside of offices with walls on 10-foot or 12-foot centers. Thus, some offices are likely to be positioned directly below loudspeakers, and some not. Such spacing results in inconsistency in the sound field in spaces of various sizes and shapes.

Additionally, most loudspeakers have an acoustic radiation pattern that is very dependent upon the frequency of excitation. At very low frequencies, the electrodynamic loudspeaker creates a reverberant field that is broad and fairly uniform. As the frequency of the input wave increases, however, the sound field produced by the loudspeaker becomes more focused and directed. Since conventional dynamic loudspeakers produce a directed coherent sound field at frequencies of interest in masking, their utilization to create a uniform, diffuse reverberant field presents a challenge.

### SUMMARY

Briefly described, the present invention comprises a sound masking system including an airflow unit housing at least one speaker generating a masking sound field. Typically, the airflow unit is an air diffuser set into a conventional suspended ceiling comprised of a metal grid and ceiling tiles. The air diffuser provides an acoustic hole in the ceiling plane whereby sound can travel into the room unencumbered by the plane of ceiling tiles. The speaker is housed within the air diffuser and is directed into the room. The speaker can be set to produce masking sound waves in a frequency that masks the human voice. The masking sound waves are free to pass directly into the room through the panel on the diffuser, instead of passing through the acoustic ceiling tiles. The masking sounds mask the undesired or distracting sounds waves.

By locating the masking speaker within the airflow unit, the masking system is moved when the airflow system is relocated due to office space reconfiguration. Most reconfigurations include an airflow unit within each newly created space, thus the sound masking system is also relocated. The relocation of both systems is combined into a single operation by locating the masking speaker within the housing of the airflow unit.

A flat panel speaker is also included in an embodiment of the sound masking system. The incorporation of a flat panel speaker aids in the wide and uniform dispersion of the masking sound field. Additionally, the flat panel speaker enables the masking driver to be located very close to the treated space which aids in eliminating the potential acoustical problems associated with mounting speakers above the ceiling plane.

The invention further includes a method of generating a masking sound field. The method includes the steps of generating a masking sound field within a movable air flow unit and directing the generated sound field into a room for attenuating sound. The method further includes detecting a sound level and filtering the detected sound level to produce a desired spectrum of sound for generating the masking sound field for attenuating sound.

### DESCRIPTION OF THE DRAWINGS

In the drawings:

FIG. 1 illustrates one embodiment of the present invention wherein a flat panel speaker is attached to the air diffuser panel of an air flow unit fitted into a ceiling grid module;

FIG. 2 is an illustration of a typical flat panel speaker compatible with the present invention;

FIG. 3 illustrates one embodiment of the present invention wherein a flat panel speaker is attached through an opening in the side panel of the air flow unit;

FIG. 4 illustrates one embodiment of the present invention wherein a flat panel speaker is attached perpendicular to the air diffuser panel of the air flow unit; and

FIG. 5 illustrates one embodiment of the present invention wherein a flat panel speaker is attached perpendicular to the side panel of the air flow unit.

### DETAILED DESCRIPTION

The present invention comprises a sound masking system including an airflow unit housing at least one speaker generating a masking sound field. The airflow unit typically comprises an air diffuser set into a conventional suspended ceiling comprised of a metal grid and acoustical ceiling tiles. The speaker is any sound generating device capable of delivering a masking sound field. The speaker is housed within the air diffuser assembly and positioned so that the emitted sound is directed into the space to be treated.

The speaker can be appropriately driven to produce sound waves with spatial and frequency characteristics that mask the human voice. The speaker also may be driven to emanate with other sonic characteristics that may mask sounds deemed to be a distraction. Such unwanted sounds may emanate from the ventilation system or other machinery in the space to be treated. The term “speaker” as used herein is defined to mean any sound generating device and is meant to encompass all such sound generating devices and their requisite components for operation and assembly.

The speaker is preferably set inside the housing of an airflow device, wherein multiple speakers may be placed. The speakers are attached to the inside of the airflow housing using conventional attachments such as screws or adhesives. The speaker may be attached to the diffuser panel of the air flow device or to other parts so long as sound can be directed into the space to be treated, such as an office. Wiring of the speakers can be done internally within the housing and running outside the housing through an appropriate opening. Preferably, speaker components and wiring can be moved simultaneously with the airflow system.

The sound masking system may also be an active system wherein a masking sound field is generated in reaction to a detected signal or sound. For example, the system may be fitted with a signal detector or microphone capable of detecting a certain sound or signal and then directing the masking sound system to emanate a masking sound field that will mask the detected sound.

Additionally, the masking sound field may be emitted upon the detection of a preset temperature or physical condition that triggers the ventilation system to activate or deactivate. Air diffusers tend to generate noise in the frequency bands normally used in masking and most occupants of ventilated spaces are accustomed to accept sounds produced by air conditioners and other ventilation equipment. However, higher airflows can result in noise levels that are unacceptable. Thus, in the case of activation of the ventilation system, the masking system can be activated to mask the noise produced by the ventilation system to aid in abating such noise. In the case of deactivation of the ventilation system, the masking system can be activated to produce 5 a sound field to abate various sounds within the space below since sound emanating from the air flow system is typically acceptable.

Sound masking involves the introduction of sound waves with certain spatial characteristics and in certain frequency ranges to abate or lessen distracting noises or to limit their travel. The addition of sound in the spectrum occupied by human voice, for example, provides a masking effect that masks the undesired sounds in a way that is not perceptible by the listener. A typical sound masking system can comprise a “pink noise” signal, a filter for filtering the signal to provide the desired spectrum of sound, an amplifier, and a sound generator or speaker directed to the area being treated. Other configurations may also be used so long as a masking sound field is produced by the sound generating device as disclosed.

The airflow devices contemplated by this disclosure typically are air diffusers of a heating, ventilating and air conditioning (HVAC) system, but other airflow devices may also be used such as an air return. Air diffusers generate sound by virtue of the turbulence created by moving air, and provide an acoustic “hole” in the ceiling plane. Typically, an enclosed office will have at least one air diffuser for incoming ventilation air, and an air return for the return of air back to HVAC equipment.

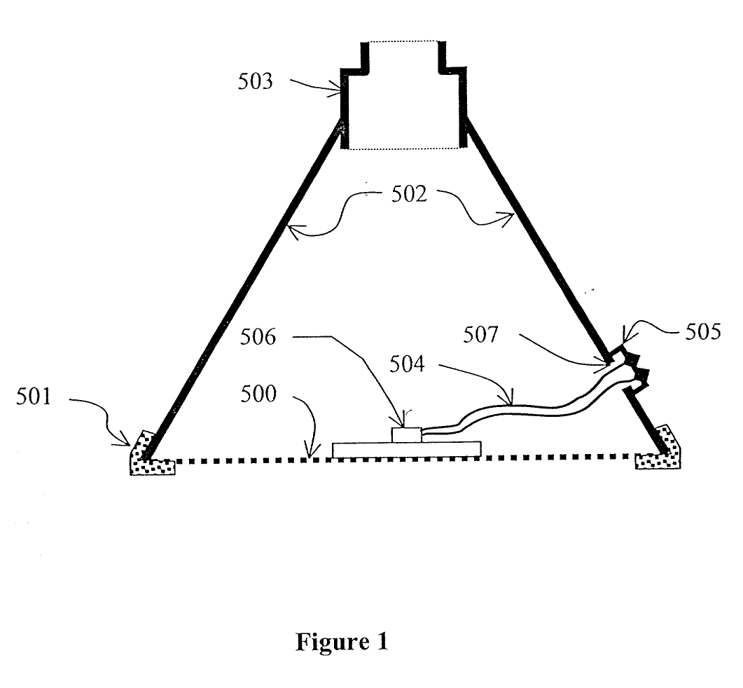

The embodiment encompassing a flat panel loudspeaker and an air diffuser in a single apparatus is illustrated in a cross-sectional view in FIG. 1. Within the illustration, the air diffuser preferably fits into a standard 2′ by 2′ suspended ceiling module. Other dimensions may also be utilized to fit ceiling module openings that are not standard.

The rectangular air diffuser illustrated in FIG. 1, comprises a diffuser panel 500 configured as a square sheet of perforated metal sized to fit within a frame element 501. The frame element 501 surrounds the perforated metal sheet 500 and also attaches and holds side panels 502. Four side panels 502 are connected to form a trapezoidal metal plenum and connects the diffuser panel 500 with an air duct coupler 503. The lower edges of the panels 502 are attached by the frame element 501 around the perimeter of the diffuser panel 500. The upper edges of the panels 502 are connected to the air duct coupler 503. The duct coupler 503 typically is a metal box with a square profile and is attached to the upper edges of the four side panels 502. The upper portion of the coupler provides a suitable connection for a square or round air handling duct such as might be used in a ceiling to conduct air to a diffuser.

A flat panel loudspeaker 506 has a frame approximately 8 to 10 inches on a side and is attached to the top surface of the diffuser panel 500 utilizing screws, adhesives, or other means of fixation. Wiring 504 for the flat panel speaker is routed through a hole 507 formed in one of the side panels 502 and terminates in a connector block 505 affixed to the outside surface of the side panel 502. The connector block 505 forms a seal over the hole 507 in the side panel 502

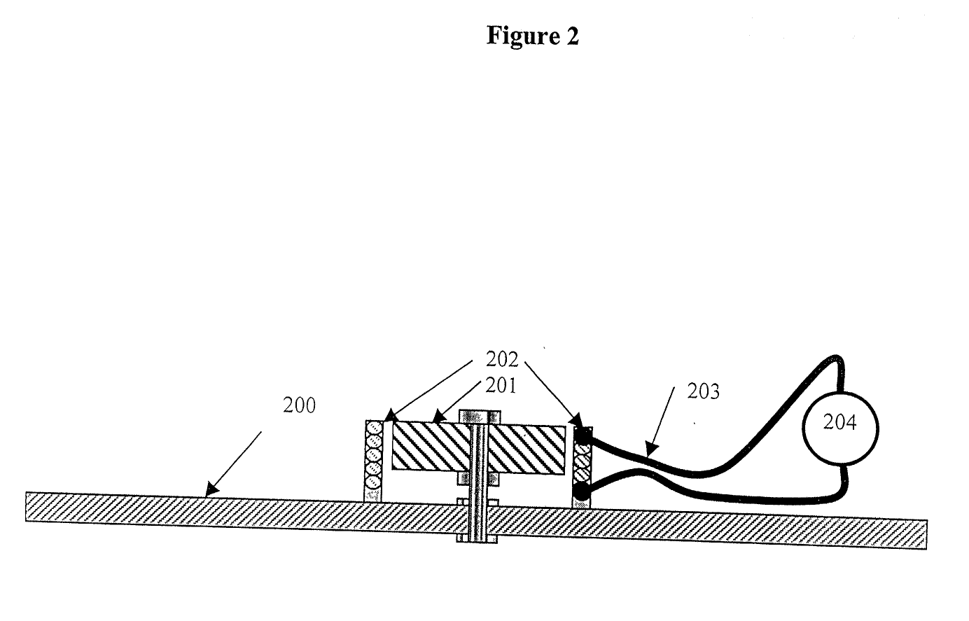

FIG. 2 illustrates a flat panel speaker compatible with the present invention. The speaker illustration of FIG. 2 is only an example, however, and other speaker configurations may also be used. Flat panel loudspeakers possess a broad acoustic radiation pattern at the frequencies required for sound masking. Thus, their use is preferred over conventional dynamic loudspeakers in masking application, although dynamic loudspeakers are acceptable and are within the scope of the invention.

The flat panel loudspeaker illustrated in FIG. 2, comprises a light, stiff radiating panel 200 of arbitrary size and a transducer. The latter comprises a magnet 201 clamped to the radiating panel 200, a voice coil assembly 202, and wiring 203 to an excitation source 204 that is not part of the flat panel loudspeaker. There are various embodiments of the transducer used in a flat panel loudspeaker. Shown is the “bender” or clamped driver. When electrical current is passed through the voice coil, the magnet and voice coil push in opposite directions, inducing a very small relative displacement, or bending, of the panel material between the voice coil and magnet mounting points. Rather than the coherent piston-like motion of a cone speaker, the motion of the flat panel is decidedly incoherent, containing many different complex modes spread over the entire surface of the radiating panel 200. This effect contributes significantly to the broad radiation pattern and lack of beaming behavior characteristic of traditional cone loudspeakers. Flat panel loudspeakers suitable for use in the present invention are available from New Transducers Ltd. (NXT), a technology research and licensing organization wholly owned by Verity Group plc., of Huntingdon, England.

There are numerous configurations of air diffusers in which one or more flat panel speakers may be mounted. One embodiment is a simple example illustrating what is considered to be the best mode of carrying out the invention, but does not encompass the range of embodiments possible for this invention. Most diffusers include vanes to direct airflow at a desired angle from the vertical axis of the diffuser, which are not shown in the present embodiment. The loudspeaker may be placed on another part of the diffuser panel and may be mounted on one of the side panels if desired, provided it still radiates into the space being treated. The loudspeaker also may be mounted below the ceiling plane, in diffusers that have elements that project into the room being treated.

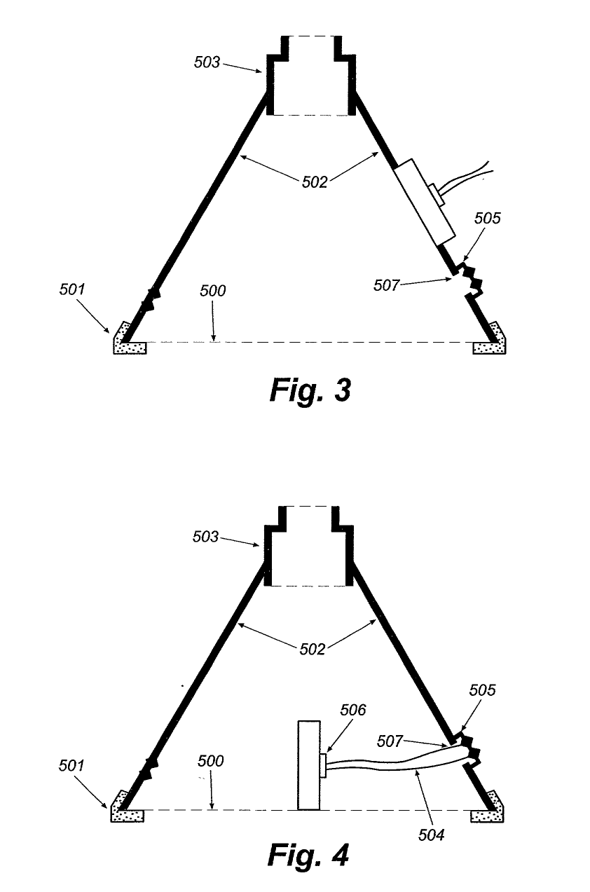

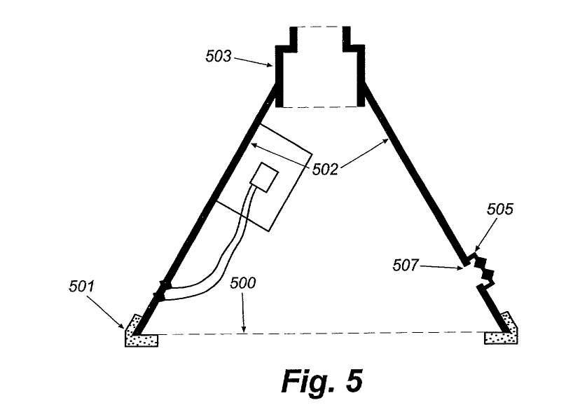

FIG. 3 is a further embodiment wherein the radiating panel 200 is attached through an opening in the side panel 502 of the air flow unit. Furthermore, as illustrated in FIGS. 4 and 5 the radiating panel 200 may be mounted in a perpendicular position. In FIG. 4 the radiating panel 200 is mounted perpendicular to the air diffuser panel 500 and in FIG. 5 the radiating panel 200 is mounted perpendicular to the side panel 502 of the air flow unit.

While Applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A sound masking system comprising:
an air flow unit housing at least one speaker generating a masking sound field.

2. The sound masking system of claim 1, wherein the air flow unit comprises an air diffuser.

3. The sound masking system of claim 2, wherein the air diffuser is a movable unit fitted into a ceiling grid module.

4. The sound masking system of claim 3, wherein the ceiling grid module is located within a suspended ceiling comprised of a grid and ceiling tiles.

5. The sound masking system of claim 1, wherein the airflow unit is an air return unit.

6. The sound masking system of claim 1, wherein the speaker is a flat panel speaker.

7. The sound masking system of claim 6, wherein the flat panel speaker is attached to an air diffuser panel.

8. The sound masking system of claim 1, wherein the masking sound field comprises sound waves having frequency ranges similar to that of human voice.

9. The sound masking system of claim 1, further including a signal detector detecting a noise level and adjusting the level of the masking sound field as needed.

10. The sound masking system of claim 9, further including a filter to determine a desired spectrum of sound for generating the masking sound field.

11. A method of generating a masking sound field comprising:
generating a masking sound field within a movable air flow unit; and
directing the generated sound field into a room for attenuating sound.

12. The method of claim 11, further including detecting a sound level.

13. The method of claim 12, further including filtering the detected sound level to produce a desired spectrum of sound for generating the masking sound field for attenuating sound.

14. A sound masking apparatus comprising:
a flat panel speaker;
a movable air unit housing the flat panel speaker and the flat panel speaker directing a masking sound field into a treated space.

15. The sound masking system of claim 14, wherein the air flow unit comprises an air diffuser.

16. The sound masking system of claim 15, wherein the air diffuser is a movable unit fitted into a ceiling grid module.

17. The sound masking system of claim 16, wherein the ceiling grid module is located within a suspended ceiling comprised of ceiling tiles.

18. The sound masking system of claim 14, wherein the airflow unit is an air return unit.

19. The sound masking system of claim 14, further including a signal detector detecting a noise level and adjusting the level of the masking sound field as needed.

20. The sound masking system of claim 19, further including a filter to determine a desired spectrum of sound for generating the masking sound field.
